(19) United States
(12) Patent Application Publication
(10) Pub. No.: US 2021/0034326 A1
(43) Pub. Date: Feb. 4, 2021

(54) Quicker Sort

(71) Applicant: Conrad Lewis Gourley, Denver, CO (US)

(72) Inventor: Conrad Lewis Gourley, Denver, CO (US)

(21) Appl. No.: 16/524,754

(22) Filed: Jul. 29, 2019

(51) Int. Cl. G06F 7/08; G06F 12/1009; G06F 3/06

(52) U.S. Cl. CPC G06F 7/08; G06F 12/1009; G06F 3/0674; G06F 3/0643; G06F 3/0604

(57) ABSTRACT

Multiple magnitude reference points more efficiently relate to a dataset. Quickersort by dividing the data into poly-[greater than 2] categories directs elements into much more specific pockets. Multi-comparisons at once bypasses multiple memory moves for 1 move. On chip comparison(s) take less actual time than memory moves. Eliminating those numerous memory moves delivers speed.

More categories mean faster sorting, beyond pragmatic considerations. Logically it should target max use of whatever given CPU it will run on, relating to the number of memory blocks the on-chip cache can hold. After ancillary data [comparison tree, category addresses, etc.] the free cache memory blocks remaining would be the maximum number of categories to implement per pass. Maximizing the discrete limit of action points. A category's working fill block stays loaded until full when, [optimally] it is discarded for that category's next block. This optimizes locality/continuity of reference. With too many categories block swap thrashing [slowing] may occur.

Having not actually implemented this method & crafting several optional categorization methods i don't know the potential degree of improvement. While I am sure it will be faster than Quicksort, it entails [& conditionally significantly] more programming to implement. My hope is it will be dramatically faster & very worthwhile for those who have real needs for exceptionally fast real number sorting.

### CROSS REFERENCE TO RELATED APPLICATIONS

Not applicable.

### STATEMENT OF FEDERALLY SPONSORED RESEARCH OR DEVELOPMENT

Not Applicable.

### THE NAMES OF THE PARTIES TO A JOINT RESEARCH AGREEMENT

Not applicable.

### BACKGROUND OF THE INVENTION

It is based on the idea that ‘divide & conquer’ is improved, made faster, by ‘sub-divide & conquer faster’.

It was a slightly fuzzy notion of taking a group of elements of a data set and using them as ‘pivots’ all at the same time.

One could sort them & then access them as a tree, with the middle value as the root.

The elements of the data set would be compared down the comparison tree to be categorized between any two adjacent pivot values.

The categories would ‘float’ freely in memory and shift/slide back & forth as expanding categories needed.

This last idea of ‘floating intervals/floating-categories’ that was more imaginary than actually practical.

That said, I have come up with 2 viable alternatives, D-Cat

[Deterministic Categorization] & COP [Categorization in One Pass] that facilitate that task.

Each has advantages & disadvantages in terms of speed, memory management & programming.

### BRIEF SUMMARY OF THE INVENTION

The method takes a sample of the data, a set of pivots.

It then sorts them.

It then uses that sorted set of pivots as a comparison tree to identify the category into which each element of the dataset fits & places it in that category.

This is done recursively on the categories until the dataset is sorted.

### BRIEF DESCRIPTION OF THE SEVERAL VIEWS OF THE DRAWING

Not applicable.

### DETAILED DESCRIPTION OF THE INVENTION

The method creates a number of categories. This could be fixed or determined at run time based on the dataset size.

A start & end addresses for each category is stored in some block of memory.

The pivot count will be one less than the number of categories. (2\hat{ }n)−1 works most neatly to create a symmetric tree.

The pivots are selected from the dataset.

They are then sorted.

For example with 8 categories there would be 7 pivots.

The middle value [pivot number4] would act as the root.

The method would seek the first unallocated element to work as the current element.

[Outlined based on an example size of 8 categories]

Based on whether the current element's value was greater than or less than the root pivot it would then be compared with the 6th or 2nd pivot respectively, and then pass comparison to either the 7th or 5th pivots OR the 3rd or 1st pivots and the final comparison would determine its correct category between two pivots.

[Pivot equivalent values could either be placed with the category immediately below them or immediately above them. While programming consistency would usually place pivot equivalent values all the same way it still works if it placed them randomly in either of the pivot adjacent categories. Pivot equivalent values could even be placed in their own categories, but for most datasets this is non-optimal]

The current element would be swapped out with the ending element of its determined category and the ending address of that category incremented by one.

[Certain variations allow for the expansion of the category at its start address and would include swapping the current element with the element immediately below the category and decrementing its start address instead]

The method checks to see if it has swapped out the element with itself.

If it has then it seeks a new unallocated element.

If not it continues using the same address as the current element.

To track whether the pass is complete or not it can have a global counter that is incremented & tested against the dataset count after the category has been incremented,

or it could be checked for in the seek process, when no more unallocated elements would remain, tested against the last address of the working array.

After all the elements have been categorized that pass is done.

Any categories above some maximum size would have a recursive pass with the method again.

Once all categories are at or below some maximum size they can be sorted using any conventional sort algorithm.

That completes the sort.

1. The method is more robust than Quicksort.
A single poor pivot can make a pass of Quicksort quite ineffective. With Quicker sort's multiple pivots, there can be several weak pivots & still a great deal of sorting progress gets accomplished each pass.

2. The method is faster than Quicksort.
While the comparisons would be either equivalent to or double that of Quicksort [depending on the categorization method used] the memory moves are a small fraction of Quicksort's.
Comparisons are done on chip where they take very little time, while memory moves in & out to RAM or disk may take magnitudes of greater time.
The largest time consumer [memory moves] in sorting is greatly reduced, so the method will be a great deal faster.
A single pass of Quicksort creates two categories, while a single working pass of Quicker sort could organize the data into 64, 128, or more categories.
It gets the elements much, much closer to where they will ultimately finish sorting, in a fraction of the time.
